(19) United States
(12) Patent Application Publication
(10) Pub. No.: US 2019/0009392 A1
(43) Pub. Date: Jan. 10, 2019

(54) Hex shank nut driver with onboard slidable sockets

(71) Applicant: Matthew Wesley Violette, Cumming, GA (US)

(72) Inventor: Matthew Wesley Violette, Cumming, GA (US)

(73) Assignee: Matthew Violette, Cumming, GA (US)

(21) Appl. No.: 15/732,213

(22) Filed: Oct. 5, 2017

Related U.S. Application Data
(60) Provisional application No. 62/604,446, filed on Jul. 7, 2017.

(51) Int. Cl. B25B 13/10; B25B 13/06; B25B 23/00; B25B 15/00

(52) U.S. Cl. CPC B25B 13/102; B25B 15/001; B25B 23/0035; B25B 13/06

(57) ABSTRACT

A hex shank nut driver with onboard slidable sockets is disclosed. The aforementioned invention being comprised of a hex-shaped shank made of a rigid metal such as stainless steel, titanium and the like and having one end configured to be received by a conventional nut driver handle and another end configured to be received by sockets thereon. Said invention providing a means for storing said often-used sockets on the shank. The shank having raised portions preventing stored sockets from contacting each other as well as a retainer ring to selectively hold a socket for driving. The sockets being different sizes allowing them to be engaged with one another and also being color coded to allow for quick selection in the field. An object of the invention is to provide a means for easy access and storage to commonly-used nut drivers for mechanics in the field.

### FIELD OF THE INVENTION

The present invention generally relates to mechanical tools. More specifically, this invention relates to multiple socket not drivers.

### BACKGROUND

Nut drivers are hand tools with a hex shank and handle that fit into various-sized sockets. These nut drivers are commonly used to secure nuts on bolts or for driving machine screws. The Heating Ventilation and Air Conditioning industry industry generally uses three, standard sizes of sockets with nut drivers: ¼-inch, 5/16-inch and ⅜-inch for hexagonal sheet metal nuts (hex nuts). Tool makers have come up with simple ways of making these size sockets available and easy to access for mechanics while working in the field. U.S. Pat. No. 8,109,183 B2 granted to Santamarina disclosed a nut driver system that incorporates a damping device that regulates over-torquing the tool when in use. U.S. Patent No. 20060191383 A1, 4882958 and 20150135504 A1 granted to Woods & Barrowman, McNeeley and East respectively, disclosed a nut driver having several staking sockets at one end of the shank for easy access. U.S. Pat. No. 9,352,455 B2 granted to Steele disclosed a nut driver having a ratchet-type shank for ease of use. While some of these inventions provide a means to easily access popular-sized sockets, little was found in the prior art that allowed for such sockets to be securely fastened to the shank of a nut driver.

### SUMMARY OF THE INVENTION

The device herein disclosed and described provides a solution to the shortcomings in the prior art through the disclosure of a hex shank nut drive with onboard slidable sockets. Users insert the shank into any hex nut driver handle (a common, standard size) and slide the onboard sockets onto the end of the shank to drive nuts. An object of the invention is to allow easy access to popular sockets used by field mechanics.

Another object of the invention is to provide a temporary, secure means to store said popular sockets on a nut driver shank.

Another object of the invention is to provide a retaining ring to allow chosen sockets to be mounted on the end of said shank to drive nuts.

Another object of the invention is to provide a proximal raised portion that prevents sockets stored on the shank from interfering with the socket in use on the end of said shank.

Another object of the invention is to provide three sockets that engage with each other for storage on said shank.

Another object of the aforementioned invention is to provide sockets with color coded surfaces that indicate socket diameter.

It is briefly noted that upon a reading this disclosure, those skilled in the art will recognize various means for carrying out these intended features of the invention. As such it is to be understood that other methods, applications and systems adapted to the task may be configured to carry out these features and are therefore considered to be within the scope and intent of the present invention, and are anticipated. With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present invention. As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements.

The objects features, and advantages of the present invention, as well as the advantages thereof over existing prior art, which will become apparent from the description to follow, are accomplished by the improvements described in this specification and hereinafter described in the following detailed description which fully discloses the invention.

### BRIEF DESCRIPTION OF THE FIGURES

The accompanying drawings, which are incorporated herein and form a part of the specification, illustrate some, but not the only or exclusive, examples of embodiments and/or features. It is intended that the embodiments and figures disclosed herein are to be considered illustrative rather than limiting. In the drawings:

FIG. 1 is a perspective view of the invention.

FIG. 2 is a section view A-A of the invention.

FIG. 3 is a side view of the invention.

Other aspects of the present invention shall be more readily understood when considered in conjunction with the accompanying drawings, and the following detailed description, neither of which should be considered limiting.

### DETAILED DESCRIPTION OF FIGURES

In this description, the directional prepositions of up, upwardly, down, downwardly, front, back, top, upper, bottom, lower, left, right and other such terms refer to the device as it is oriented and appears in the drawings and are used for convenience only; they are not intended to be limiting or to imply that the device has to be used or positioned in any particular orientation.

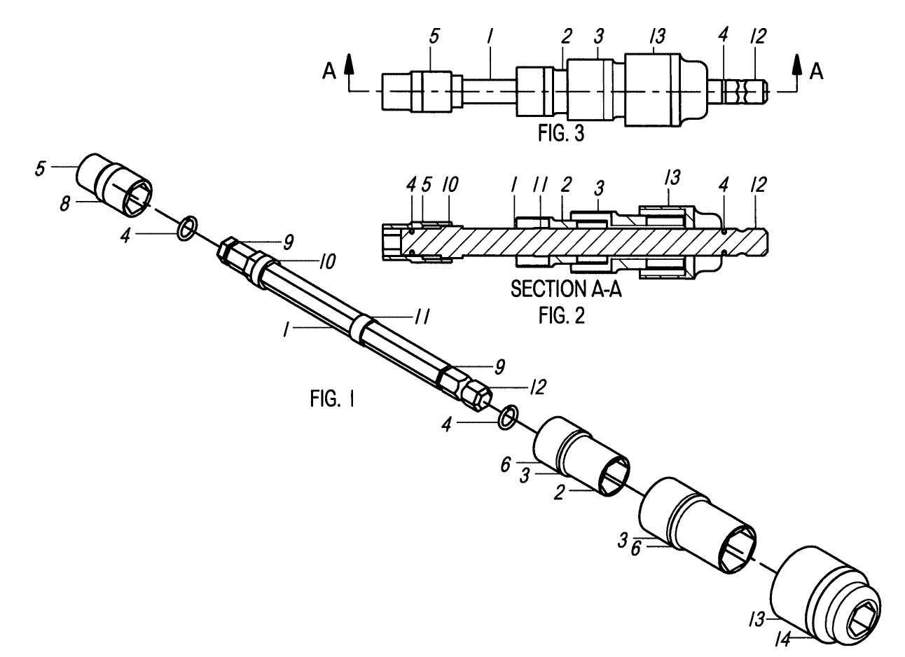

FIG. 1 showing a perspective front view of the invention having a hexagon-shaped shank 1 compatible with common nut driver handles on one end 12 and being comprised of a rigid metal such as, but not limited to, steel, titanium and the like. Said invention having at least, but not limited to, at least four double-sided sockets 2,3,5,13. Said sockets being of various diameters to fit various nuts and made of a rigid material such as steel, stainless steel and the like. Another end of said shank 1 having a groove 9 configured to accept retaining ring 4 allowing said sockets to be releasably secured on a distal end of said shank 1. In another embodiment, said groove 9 and ring 4 may also be configured on a distal end of said shank 1 allowing any stored sockets to be releasably secured onto said shank 1. FIG. 1 also showing boundaries of color-coded areas 6,7 and 8 on said sockets 2,3 5, and 14. Colors to include, but are not limited to, yellow, blue, red and green etc.

FIG. 2 showing a section view of the aforementioned invention having raised portions 10 and 11 configured to prevent said sockets 2,3 and 5 from unwanted movement when stored on said shaft 1. It is clearly illustrated that orifices in said sockets 2,3 and 5 (being configured to with a hexagonal aperture that allows said sockets to be slidably positioned on said shank) do not allow said sockets to slide further proximally than said raised portions 10 and 11.

FIG. 3 showing a side view of the aforementioned invention having said sockets 2 and 3 in a stored position along shank 1 and socket 5 in a position at the end of said shank 1 ready for use. In one embodiment, a distal end configured to receive said sockets of shank 1 being magnetized.

1. a hex shank nut driver with onboard slidable sockets.

2. The shank nut driver with onboard slidable sockets device of claim 1 providing a means for easy access to popular nut driver sockets used by field mechanics.

3. The shank nut driver with onboard slidable sockets device of claim 1 providing a temporary, secure means to store said popular sockets on a nut driver shank.

4. The shank nut driver with onboard slidable sockets device of claim 1 providing a retaining ring to allow chosen sockets to be mounted on the end of said shank to drive nuts.

5. The shank nut driver with onboard slidable sockets device of claim 1 providing a proximal raised portion that prevents sockets stored on the shank from interfering with the socket in use on the end of said shank.
